(19) United States
(12) Patent Application Publication
(10) Pub. No.: US 2026/0237210 A1
(43) Pub. Date: Aug. 13, 2026

(54) AUTOMATIC PREVIEW GENERATION FOR VIDEOS

(71) Applicant: ROKU, INC., San Jose, CA (US)

(72) Inventors: Unnikrishnan R. Nair, Bengaluru (IN); Fei Xiao, San Jose, CA (US); Abhishek Bambha, Burlingame, CA (US); Amit Verma, Sunnyvale, CA (US); Atishay Jain, Mountain View, CA (US); Jonathan Ve Vance, Bangalore (IN); Jose Sanchez, San Jose, CA (US); Lian Liu, Rancho Palos Verdes, CA (US); Nam Vo, San Jose, CA (US); Pulkit Aggarwal, San Jose, CA (US); Ronica Jethwa, San Jose, CA (US); Ritwick Babbar, Fremont, CA (US); Thejaswi Hanumantha Raya, Fremont, CA (US)

(73) Assignee: ROKU, INC., San Jose, CA (US)

(21) Appl. No.: 19/052,941

(22) Filed: Feb. 13, 2025

(51) Int. Cl. G06V 20/40; G06T 7/00

(52) U.S. Cl. CPC G06V 20/47; G06T 7/0002; G06T 2207/10016; G06T 2207/30168

(57) ABSTRACT

Disclosed herein are system, apparatus, article of manufacture, method and/or computer program product embodiments, and/or combinations and sub-combinations thereof, for automatic preview generation for videos. An example embodiment operates by identifying content for which to generate a preview and a plurality of shots within the content. A subset of frames is selected based on a sharpness indicator. An aesthetic score for each of the subset of sharpest frames is generated based both a positive score and a negative score for each frame as generated by a visual language model (VLM). A preview frame is selected, and a preview is generated for the content based on the preview frame. The preview of the content is provided for display.

### BACKGROUND

### FIELD

This disclosure is generally directed to automatic preview generation for videos.

### SUMMARY

Provided herein are system, apparatus, article of manufacture, method and/or computer program product embodiments, and/or combinations and sub-combinations thereof, for an automatic preview generation system for videos.

An example embodiment operates by identifying content for which to generate a preview and a plurality of shots within the content. A subset of frames is selected based on a sharpness indicator. An aesthetic score for each of the subset of sharpest frames is generated based both on a positive score and a negative score for each frame as generated by a visual language model (VLM). A preview frame is selected, and a preview is generated for the content based on the preview frame. The preview of the content is provided for display.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 is a block diagram illustrating example functionality for the automatic generation of a preview for videos, according to some embodiments.

FIG. 4 is a flowchart for a method illustrating example operations of a preview generator (PG), according to some embodiments.

FIG. 5 is a flowchart for a method illustrating additional processing that may be performed by preview generator (PG), according to some embodiments.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for an automatic preview generation system for videos.

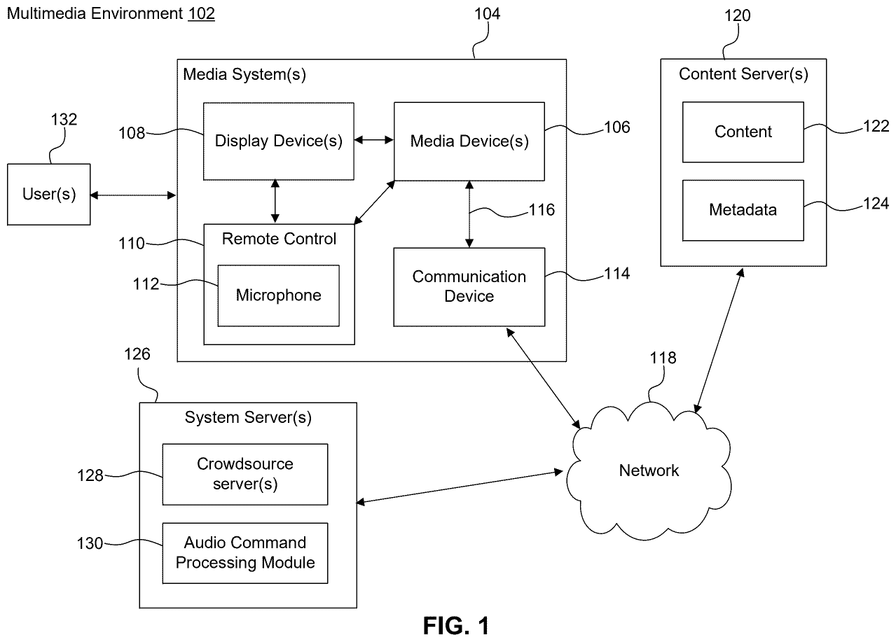

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users'viewing experience at particular portions of the movie (for example, when the soundtrack of the movie is difficult to hear), and turning closed captioning off may enhance users'viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing module 130. As noted above, the remote control 110 may include a microphone 112. The microphone 112 may receive audio data from users 132 (as well as other sources, such as the display device 108). In some embodiments, the media device 106 may be audio responsive, and the audio data may represent verbal commands from the user 132 to control the media device 106 as well as other components in the media system 104, such as the display device 108.

In some embodiments, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

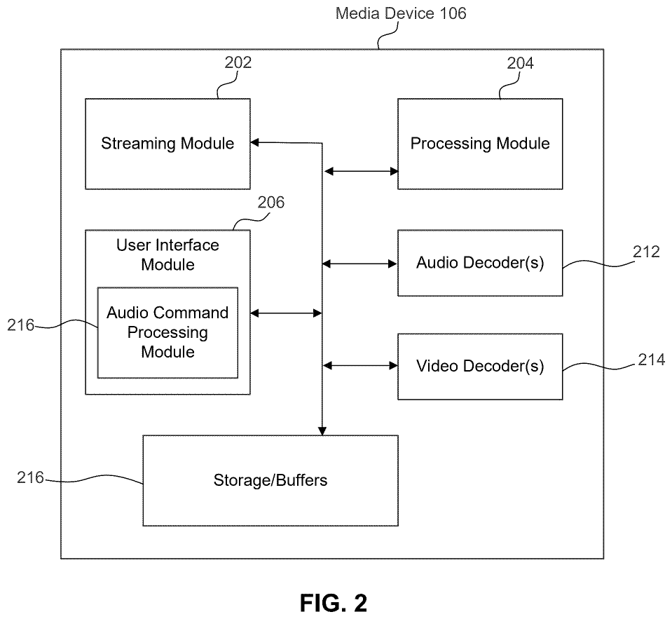

In some embodiments, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

### Automatic Preview Generation for Videos

With so much digital content available for consumption by users, it is often difficult for a user to decide what content to watch or otherwise consume, especially when it comes to newly available digital content with which the user may not be previously familiar. As such, it is often helpful for a user to watch a preview of content to make a determination as to whether or not to watch the content. An engaging preview can increase the consumption of any digital content, such as videos, movies, shows, and other multimedia content.

Existing approaches to generating a preview require a user to watch a movie, and select a portion of the movie that the user subjectively thinks will appeal to other users. These existing approaches are tedious, labor-intensive, time consuming, result in inaccuracies, and cannot be improved upon. Moreover, these existing approaches cannot scale to handle large numbers of video, particularly for platforms that require rapid turnaround on diverse content.

Embodiments herein solve these technological problems by using a multi-stage, automated pipeline that leverages AI and deep learning techniques to transform raw video files into engaging previews. For example, where a user previously would have had to subjectively identify and select one or more portions of content that they believe will appeal to other users, embodiments herein use a multi-stage, automated pipeline that leverages objective rules to automatically select the best frame candidates based on image quality and/or aesthetic appeal, and a visual language model (VLM) to refine the selection, thereby converting a subjective process into objective process that results in a preview that has high impact, consistency, and alignment with the video's narrative.

Morever, embodiments herein can automatically generate multiple previews for a single piece of content (such as a movie or show), tailoring those previews to different genres. Finally, embodiments herein can computationally learn from feedback what features within a particular preview increase user engagement, and apply these lessons to generating new previews for both the same content and different content across different genres.

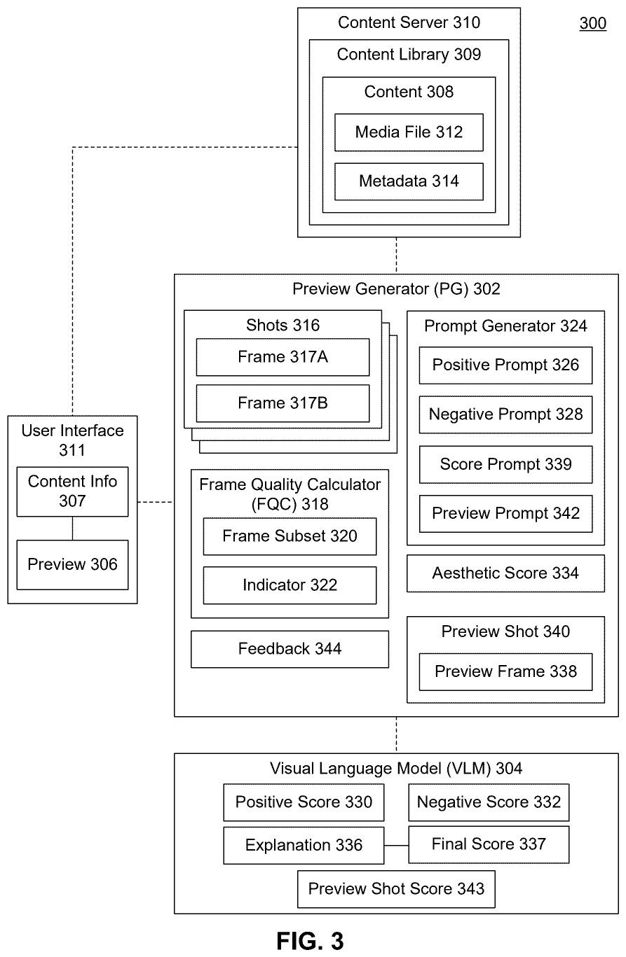

FIG. 3 is a block diagram 300 illustrating example functionality for the automatic generation of a preview for videos, according to some embodiments. A preview generator (PG) 302 may automate the generation of promotional content or previews 306 for content 308 through leveraging the capabilities of a visual language model (VLM) 304. Rather than relying on manual, resource consuming, and labor-intensive processes, PG 302 may automatically and computationally identify and extract the portions of content 308 that would be suitable for a preview 306. In some embodiments, with regards to the multimedia environment 102 illustrated in FIG. 1, PG 302 may be communicatively coupled to the content server(s) 120 via network 118 and provide a generated preview 306 directly to media system 104 for access by user(s) 132 or indirectly via content server(s) 120.

PG 302 may automatically generate engaging previews 306 for the content 308 of a content delivery system, such as a content server 310. The content server 310 may then make the preview 306 along with the underlying content 308 available to users via a user interface 311.

The users may scroll or browse the various content of a content library 309, via user interface 311. User interface 311 may allow the users to watch the previews 306 generated for the content 308, and select the most interesting or engaging content 308 (which may be influenced by the preview 306). PG 302 also allows for the automated generation of multiple previews 306 for the same piece of content 308. These different previews 306 may be used in different circumstances, with different users, with different genres, and/or may be tested against each other to identify the best performing (e.g., most engaging) preview 306 for any of the content 308.

In some embodiments, content server 310 may include one or more servers or other computing devices configured to store and distribute or make available content 308 which may be organized across one or more content libraries 309. Content library 309 may include any storage system or device that includes one or more pieces, types, or titles of content 308. In some embodiments, each content library 309 may be dedicated to store only a particular type of content (e.g., movies, shows, books, music, games, etc.) or a particular genre (e.g., drama, action, musicals, opera, etc.). In some embodiments, content library 309 may include or store any assorted pieces of content 308, across publishers, genres, media types, etc.

Content 308 may include any digital content (or content that has been made digitally available), including but not limited to a show, movie, game, video, book, or other multimedia content. For simplicity, only a single content server 310 and content library 309 including a single piece of content 308 is illustrated, however it is understood system 300 may include any number of content servers 310, content libraries 309, and pieces of content 308 organized in any manner.

As indicated above, a user may access the content 308 (or content library 309) via a user interface 311. In some embodiments, user interface 311 may display content info 307 and the preview 306 corresponding to content 308. The content info 307 may include various information about the content including title, rating, genre, year of production, directors, artists, etc.

The preview 306 may include a visual depiction of a portion of the content 308. One example of a preview 306 may include a movie poster. For example, the preview 306 may include a still image or frame extracted from the content 308, which may be displayed as a movie poster.

Another example of a preview 306 may include a trailer for a movie. For example, the preview 306 may include a video clip (which may or may not include corresponding audio) or a GIF, including a set of frames extracted from the content 308. This preview 306 may be watched by the user prior to selecting the underlying content for consumption.

In some embodiments, preview 306 may include both a still image and a trailer. For example, the still image may be displayed in user interface 311 and upon a selection of the still image (or hover with a mouse or other digital pointer) may play the video clip within user interface 311.

Preview 306 may include any visual representation of content 308, including still image(s) and/or video clip(s). In some embodiments, user interface 311 may allow a user to select the content info 307 or preview 306 to select and watch or otherwise consume the underlying content 308. For example, a user may select the title of a movie or the preview 306 to watch the movie.

In some embodiments, content 308 may include an original preview, as received by a distributor or publisher of the content 308. However, the content 308 may be underperforming (e.g., not being selected by users as often as desired or anticipated), the content 308 may be categorized across different genres and the original preview is unsuitable for each different genre, or there may be no original preview available for the content 308. In these and other situations, the content 308 may be provided or otherwise made available to PG 302, which may automatically generate one or more new previews 306 for the content 308. For simplicity, a single preview 306 is illustrated, however it understood PG 302 may generate multiple previews 306 which may be made available for content 308 and used in different circumstances, for different users, or for different genres applicable to content 308. As will be discussed in greater detail below, PG 302 may create multiple genre-specific previews 306 for content 308.

Rather than relying on the manual creation of such previews, PG 302 may automate the creation of a preview 306 (or multiple previews 306) for a piece of content 308. For example, content server 310 may submit to PG 302 a request to generate a new preview 306 for a selected piece of content 308. For example, when content server 310 receives new content 308, the new content 308 may be provided to PG 302 to generate one or more previews 306.

In some embodiments, the content 308 may include a media file 312 and metadata 314. Media file 312 may include one more files, including video and/or audio content, that together comprise the content 308 (for simplicity only a single media file 312 is illustrated, however a piece content 308 may include or comprise multiple media files 312). As used herein, the terms content 308 and media file 312 may be used interchangeably, unless otherwise specified.

Metadata 314 may include any information about the content 308. In some embodiments, metadata 314 may include information that may be relevant to a consumer or potentially consumer of the content. Example metadata 314 includes the name of the content 308, date of publication/production, the actors/artists, genre, plot description, length, keywords, captions, director name, etc. In some embodiments, the metadata 314 may be used as a source for content info 307.

Upon receiving, retrieving, downloading, or otherwise accessing content 308 from content server 310 (or another source), PG 302 may divide the content 308 into multiple shots 316, or otherwise identify multiple shots 316 within the content 308. Each shot 316 may include a set of multiple adjacent frames 317 (e.g., 317A, 317B) from content 308, and the shot 316 may range from one second to several minutes or longer in playable length.

Each frame 317A, 317B may be a still image of content 308. For simplicity, only two frames 317A, 317B are illustrated, however it is understood that a shot 316 may include any number of frames 317A, 317B. As used therein, the term frame 317 or frames 317 may be used to refer to frames 317A and 317B generally. In some embodiments, a shot 316 may correspond to when a recording was started and stopped within a particular scene during a creation of the content. In some embodiments, a shot 316 may refer to a scene from content 308.

In some embodiments, PG 302 may include or employ a neural network or neural network model to divide content 308 into shots 316 or to define, extract, or otherwise identify shots 316 from content 308. One example neural network model that may be utilized by PG 302 is TransNetV2, which is a deep network architecture for fast shot transition detection, however it is understood that PG 302 is not limited by the example of TransNetV2.

In some embodiments, PG 302 may receive shots 316 from content server 310 or another source. In some embodiments, each shot 316 may include or be formatted as a start time (or start frame) and end time (or end frame) of the shot 316 within a time of the content 308. Example shots 316 may be 0-298, 299-1095, and 1096-1284, in which each number indicates a start/stop position (e.g., time or frame) in a timeline of content 308 or frame numbering. For example, the first shot may begin at time 0 (or frame 0) and go until time 298 (of frame 298). Similarly, the second shot may begin at time or frame 299 and end at time or frame 1095, etc. In some embodiments, each shot 316 may be its own file. In some embodiments, each shot 316 may reference a portion of media file 312 including the shot 316.

In some embodiments, a frame quality calculator (FQC) 318 may identify a frame subset 320 from the shots 316. The frame subset 320 may include a set of high quality or the highest quality frames 317 across all the shots 316 as determined based on the value of an indicator 322. In some embodiments, FQC 318 may calculate or compute the value of indicator 322 against which to measure frame quality.

In some embodiments, the indicator 322 may include a sharpness value. Sharpness may refer to the video quality, such that a sharp frame is not blurred (e.g., because a blurred frame would not be enticing to a user to want to select the content 308). While the indicator 322 referred to herein will primarily be describes as measuring sharpness, it is understood that in other embodiments, other features or metrics in addition to and/or in lieu of sharpness may be computed and used by FQC 318 to identify the highest quality frames 317 from across the shots 316. For example, other indicators 322 may include brightness or contrast, which may be used in addition to or in lieu of sharpness.

In some embodiments, FQC 318 may use a variance of laplacians to compute the sharpness of frames for indicator 322. For example, in a particular shot 316, FQC 318 may compute the variance of laplacians (sharpness indicator 322) for each frame 317 within the particular shot 316. Then, FQC 318 may select the frame(s) 317 with the highest value for indicator 322. For example, FQC 318 may select the top five frames 317 (e.g., with the highest value for indicator 322) in each shot 316 as the frames of frame subset 320. Or, for example, FQC 318 may select all the frames 317 with a value for indicator 322 greater than a threshold value across any or all of the shots 316 for the frame subset 320.

In some embodiments, certain shots 316 may be excluded from processing by FQC 318 (which saves processing time and resources). These excluded shots 316 may include shots from the last portion of content 308, which may include spoilers. For example, any shots 316 in the final 30 minutes of a movie may be excluded from processing by FQC 318.

The result of FQC 318 processing may be generating a frame subset 320, which may include any number of the highest quality frames across multiple shots 316 that have been selected based on the value of one or more indicators 322 (e.g., such as sharpness). The frames from the frame subset 320 may then be further evaluated by VLM 304 to identify one or more preview frames 338, as described in further details below.

In some embodiments, a prompt generator 324 may generate one or more prompts that are used to cause VLM 304 to perform one or more actions or functionality with regard to generating preview 306.

A prompt may include one or more lines of text organized across one or more documents that is particularly formatted to by understandable by a visual language model (VLM) 304. Example prompts which may be generated by prompt generator 324 include a positive prompt 326, a negative prompt 328, a score prompt 339, and a preview prompt 342. In other embodiments, different or additional prompts may be generated. A prompt may also include some sort of visual input (e.g., such as a shot 316, frame subset 320, another set of one or more frames 317, or any other portion of content 308) upon which some processing is to be performed in accordance with the instructions of the prompt.

VLM 304 may include an artificial intelligence, machine learning, or deep learning model that is configured to execute data processing commands from plain-text (e.g., not requiring computer language or coded input) on some video or other visual input. VLM 304 may be an example of a multimodal large language model (LLM). VLM 304 may include any computing system that is configured to perform processing tasks based on visual inputs (e.g., content 308, shots 316, frames 317, frame subset 320, etc.) in accordance with text-based or plain language instructions organized as prompts generated by prompt generator 324.

In some embodiments, VLM 304 may be configured to create original content from the visual input, extract portions of the visual input as output, and/or respond to queries or perform other processing with regard to the visual input in accordance with a prompt. In some embodiments, VLM 304 may be configured to understand what is visual features or characteristics are being depicted or displayed in a particular frame 317 (or set of frames 317) and respond to a query or instruction accordingly. In some embodiments, VLM 304 may include a generative pre-training transformer (GPT).

In some embodiments, the frame subset 320 may include a set of visually appealing (e.g., clear or sharp) frames 317 as selected across shots 316 of content 308 based on indicator 322. However, some of the frames of frame subset 320 may not be relevant to the plot line of the content 308, may include inappropriate images for a preview 306, may include spoilers that may ruin a user's enjoyment of the content 308, or may include other features that would not make for a good, acceptable, or engaging preview 306. In some embodiments, PG 302 may use various prompts with VLM 304 to identify the most relevant frames 317 (of frame subset 320) for generating a preview 306 for content 308.

In some embodiments, positive prompt 326 may direct VLM 304 to identify (and/or score) which frames (of frame subset 320) include favorable features for preview 306. Correspondingly, negative prompt 328 may direct VLM 304 to identify (and/or score) which frames (of frame subset 320) include unfavorable (e.g., inappropriate or undesirable) content that is to be excluded from preview 306.

As an example, content 308 may be the movie “Jurassic Park”. Positive prompt 326 may instruct VLM 304 to generate “An eye-catching movie poster” based on the plot of the content 308. In some embodiments, the plot may be retrieved from metadata 314 and may include a description such as “the building of an amusement park with dinosaurs where things go wrong.” The visual input may include the frame subset 320.

However, rather than generating the movie poster, VLM 304 may be configured to generate a positive score 330 indicating a similarity between each frame (of the frame subset 320) relative to the positive prompt 326. For example, VLM 304 may determine or score how closely each frame of frame subset 320 corresponds to being an “eye catching movie poster” related to the plot of “the building of an amusement park with dinosaurs where things go wrong” (as indicated by positive prompt 326). In some embodiments, positive score 330 may include a cosine similarity score (though in other embodiments, different similarity scorings may be used). The cosine similarity score may indicate on a scale of 0-1 or 1-10 or any other scale, how closely VLM 304 has rated each frame as being an eye-catching movie poster for Jurassic Park.

In some embodiments, VLM 304 may identify elements from plot or otherwise included in positive prompt to generate the positive score 330. For example, frames with dinosaurs may include a higher positive score 330 than frames without dinosaurs, since dinosaurs are related to the plot.

In some embodiments, positive prompt 326 may include any additional details that are deemed favorable for a preview 306. In some embodiments, these details may be extracted or determined from metadata 314. For example, if the genre is “action”, frames with action sequences or depicting action are preferred. As such, any action frames may score higher than non-action frames in generating an genre-specific preview 306 for the action genre. In some embodiments, any frames with a positive score 330 below a positive score threshold may be discarded without further processing.

In some embodiments, the same content 308 may span different genres. For example, Jurassic Park may also be included in the genre of “family film”. As such, frames depicting children may be favored over frames without children for a preview 306 for the family film genre. In some embodiments, VLM 304 may return two scores for each frame if two different previews are being generated for two different genres (e.g. a positive score 330 for the action genre, and a positive score for the family genre). Then when Jurassic Park appears in user interface 311 in the action genre, an action preview 306 may be displayed. And when Jurassic Park appears under the family genere, the family preview 306 may be displayed.

As noted above, the negative prompt 328 may indicate what features or visuals are prohibited or undesirable in a frame that may be a candidate frame for preview 306. Example negative features may include nudity, blood, violence, or gore. In some embodiments, a negative feature may include any frame from the final 30 minutes of movie (e.g., thus to avoid any spoilers). Similar to what is described above with respect to the positive prompt 326, VLM 304 may process the frames of frame subset 320 in accordance with the negative prompt 328 to generate a negative score 332.

The negative score 332 may indicate a similarity between a frame and the negative prompt 328 (e.g., indicating which frames include the negative features). Thus a high negative score 332 may indicate a high presence of negative features (e.g., a frame that should not be used for preview 306). In some embodiments, any frames with a negative score 332 above a negative score threshold may be discarded without further processing.

In some embodiments, the positive score 330 may be generated first and the negative score 332 second. In some embodiments, the negative score 332 may be generated first and the positive score 330 second. In some embodiments, the positive prompt 326 and negative prompt 328 may be combined as one prompt and the positive score 330 and negative score 332 may be generated simultaneously by VLM 304. For example, when evaluating a single frame, VLM 304 may generate both the positive score 330 and negative score 332 for that frame, rather than processing the same frame twice.

In some embodiments, PG 302 may calculate an aesthetic score 334. In some embodiments, the aesthetic score 334 may be calculated for each frame for which a positive score 330 and negative score 332 was generated. In some embodiments, the aesthetic score 334 may only be calculated for those frames with a positive score 330 above the positive score threshold (if any) and/or a negative score 330 below the negative score threshold (if any). In some embodiments, the aesthetic score 334 may be the positive score 330 minus the negative score 332. Thus, a frame with a high aesthetic score 334 may include more the positive visual elements (as indicated by the positive prompt 326) and fewer negative visual elements (as indicated by the negative prompt 328).

In some embodiments, PG 302 may select some number of frames with the highest aesthetic score 334 (e.g., the 100 frames with the 100 highest aesthetic scores 334, though in other embodiments, other numbers of frames may be used). In some embodiments, a preview 306 may be generated by simply selecting the frame with the highest aesthetic score 334 as being a preview frame 338. However, if there is a tie and multiple frames share the same highest aesthetic score 334, multiple previews 306 may be generated, or additional processing (as described in further detail below may be performed).

As referenced above, prompt generator 324 may generate a score prompt 339. In some embodiments, score prompt 339 may request or command VLM 304 to generate a final score 337 to help identify which frame(s) to use as preview frame(s) 338 (e.g., from the frames selected based the aesthetic score 334). For example, score prompt 339 may be provided to VLM 304 with the top 100 frames as visual input.

In some embodiments, score prompt 339 may indicate a parameter or parameters upon which to generate the final score 337. An example parameter may be “rate how well each frame would look as a movie poster for this movie on a scale of 1-100”. Additionally, score prompt 339 may request an explanation 336 on the rating for the final score 337. This request of an explanation 336 may cause or contribute to VLM 304 generate final scores 337 (e.g., for each of the top 100 frames) with consistency in the scoring between any two selected frames. Further, the score prompt 339 may cause VLM 304 to generate scores relative to other frames, rather than simply detecting the present of various positive or negative features in each individual frame as may be done with respect to the positive prompt 326 and negative prompt 328.

In response to score prompt 339, VLM 304 may generate both explanation 336 and a corresponding final score 337 for each of the input frames. The score 337 may be a value on any scale, which may be specified by score prompt 339 (e.g., 0-1, 1-100, 1-1000, A-F, etc.). The explanation 336 may include one or more statements or sentences generated by VLM 304 that explains the rationale used by VLM 304 in generating each final score 337.

In some embodiments, PG 302 may select some number of frames with the highest final score 337 (e.g., such as the top 25 frames, though other numbers of frames could be used in other embodiments) as potential or candidate preview frames 338. In some embodiments, preview frame 338 may be a frame that may be used as the still image or movie poster for the preview 306. In some embodiments, the preview frame 338 may be the frame around which a preview shot 340 (or trailer) is generated).

In some embodiments, for each candidate preview frame 338, PG 302 may generate a preview shot 340. In some embodiments, preview shot 340 may include a selection of multiple adjacent frames 317 before and/or after the preview frame 338. In some embodiments, PG 302 may select use a standard number of frames (e.g., 100 frames before and 50 frames after preview frame 338) to generate preview shot 340. In some embodiments, preview shot 340 may include the shot 316 in which preview frame 338 exists. In other embodiments, preview shot 340 may be generated in other various ways.

As noted above, in some embodiments, prompt generator 324 may generate a preview prompt 342. Preview prompt 342 may do additional checks on the preview shot 340 to ensure it meets the standards for a preview 306. This additional check may be beneficial because preview shot 340 now includes new and additional frames which may include visual features prohibited by negative prompt 328 (e.g., such as nudity, blood, or swearing), or some candidate preview shots 340 may include more positive features than others, as indicated in positive prompt 326. In some embodiments, preview prompt 342 may include a command from VLM 304 to re-evaluate each preview shot 340 in view of negative prompt 328 and/or positive prompt 326, and generate a preview shot score 343.

Then, for example, PG 302 may select the preview shot(s) 340 with the highest preview shot score 343 for preview 306. In some embodiments, preview 306 may include preview frame 338 (e.g. of the selected preview shot 340) as a still image, and when a user hovers over the preview frame 338, the corresponding preview shot 340 may play (with or without corresponding audio) in user interface 311. Upon the completion of the preview shot 340, the preview frame 338 may be displayed again.

In some embodiments, PG 302 may preform testing with the highest scoring (e.g., based on preview shot score 343) preview shots 340. The testing may include presenting different high scoring (based on preview shot score 343) preview shots 340 to the same and/or different users, and monitoring engagement and selection of the preview frame 338 and/or underlying content 308. In some embodiments, this feedback 344 may then be used by PG 302 to select an optimal or preferred preview shot 340 to be used for preview 306 for content 308 moving forward in subsequent generation of new previews 306, for the same or different content 308. In some embodiments, this feedback 344 may be used to further refine the preview shot generation process, including the prompts generated by prompt generator 324. For example, patterns or similarities across different preferred preview shots 340 for different content 308 may be analyzed and used to refine positive prompt 326 and/or negative prompt 328.

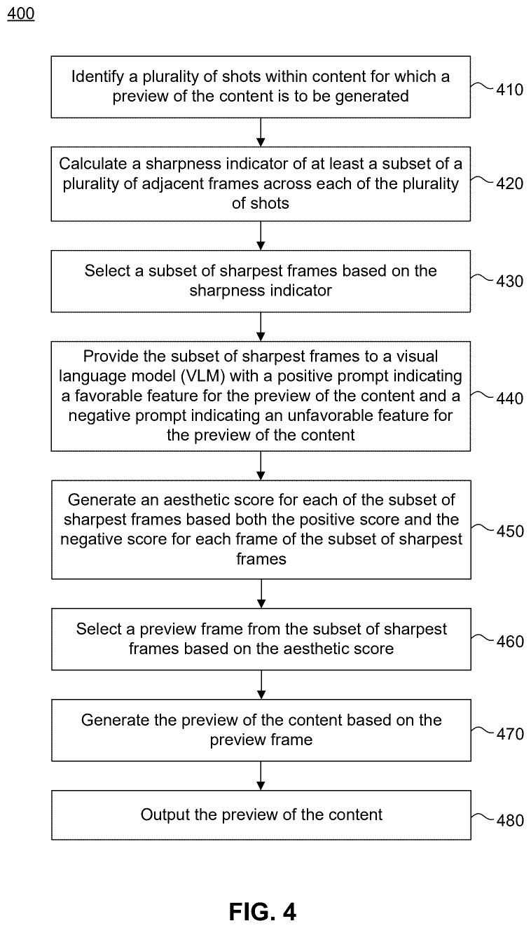

FIG. 4 is a flowchart for a method 400 illustrating example operations of a preview generator (PG) 302, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIG. 3. However, method 400 is not limited to that example embodiment. For example, the media device 106 may perform the operations described below with respect to method 400.

In step 410, a plurality of shots are identified within content for which a preview of the content is to be generated. For example, PG 302 may identify or receive an indication of the various shots 316 of content 308. Each shot 316 may include a section of the content 308 that was filmed, recorded, or created together (e.g., as a single scene or the portion of content between the beginning and pausing or stopping of recording within a scene). In some embodiments, shot 316 may include a scene of content 308. Shot 316 may include any section of content including multiple frames 317.

In some embodiments, PG 302 may receive a request from content server 310 to generate a preview 306 for content 308, which may include one or more media files 312 and metadata 314. In some embodiments, the request may specify a particular genre or category corresponding to content 308 for which to generate a genre-specific preview. For example, the request may indicate to create a preview 306 for content 308 in the action genre. Or, for example, the request may specify to create a preview 306 that may be used for different genres (e.g., a preview 306 that may be used for both the action genre and family genre). In some embodiments, the request may include a plot of the content 308 which may identified in metadata 314.

In step 420, a sharpness indicator is calculated for at least a subset of a plurality of adjacent frames across the plurality of shots. For example, a frame quality calculator (FQC) 318 may calculate indicator 322 for the different frames 317A, 317B of the various shots 316, each shot 316 may include a set of two or more adjacent frames 317. The indicator 322 may be a value related to the sharpness of the frames 317A, 317B, because blurry frames do not make for compelling previews 306. In other embodiments, indicator 322 may include other features (e.g., contrast, brightness, etc.) in addition to or in lieu of sharpness.

In step 430, a subset of sharpest frames are selected based on the sharpness indicator. For example, FQC 318 may select a subset of the frames 317A, 317B across each of the shots 316 or across multiple shots 317 based on the (sharpness) indicator 322. These selected frames may be identified as frame subset 320.

In step 440, the subset of sharpest frames are provided to a visual language model (VLM) with a positive prompt indicating a favorable feature for the preview of the content and a negative prompt indicating an unfavorable feature for the preview of the content. For example, prompt generator 324 may generate both a positive prompt 326 indicating one or more favorable features for a frame to be used as preview frame 338 and a negative prompt 328 indicating one or more negative, unfavorable, or prohibited features for a frame to be used as preview frame 338. In some embodiments, VLM 304 may receive the frame subset 320 as visual input with the positive prompt 326 and return a positive score 330 for each frame of the frame subset 320. VLM 304 may also receive or use the frame subset 320 as visual input with the negative prompt 328 and return a negative score 332 for each frame of the frame subset 320. In some embodiments, VLM 304 may only receive or only use those frames with a positive score 330 above a positive score threshold as input frames for evaluating the negative prompt 328.

In some embodiments, the scale for the both the positive score 330 and negative score 332 may be the same or compatible. For example, if positive score 330 is 0-100, negative score 332 may also be on 0-100. In some embodiments, if it is more important to avoid negative features, then the scale for the negative score 332 may be weighted. For example, if positive score 330 is 0-100, the negative score 332 may be 50-100, thus the presences of any negative feature may be weighed more heavily than the presence of a positive feature in a frame 317.

In step 450, an aesthetic score is generated for each of the subset of sharpest frames based both the positive score and the negative score for each frame of the subset of sharpest frames. For example, PG 302 may generate an aesthetic score 334 for each frame of frame subset 320 by subtracting negative score 332 from positive score 330.

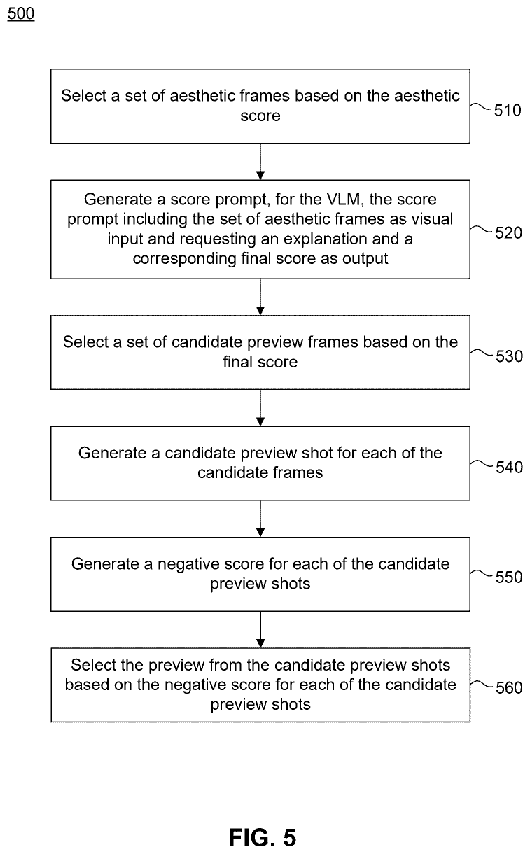

In step 460, a preview frame is selected from the subset of sharpest frames based on the aesthetic score. For example, PG 302 may select the preview frame 338 based on the highest aesthetic score 334 of the frames from frame subset 320. If there are multiple frames with the same highest aesthetic score 334, then PG 302 may perform additional processing as described with respect to FIG. 5 with respect to the frames with the highest aesthetic scores 334. In other embodiments, the additional processing of FIG. 5 may be performed prior to or as part of selecting the preview frame 338.

In step 470, the preview of the content is generated based on the preview frame. For example, PG 302 may generate a preview shot 340, which may include a plurality of frames adjacent to the preview frame 338 in the content 308. The adjacent frames may include frames prior to and/or subsequent to preview frame 338. In some embodiments, preview shot 340 may be the shot 316 that includes the selected preview frame 338.

In step 480, the preview of the content is output. For example, PG 302 may make the selected or generated preview shot 340 available to content server 310 and/or user interface 311 to be accessible or used as preview 306.

FIG. 5 is a flowchart 500 for a method illustrating additional processing that may be performed by preview generator (PG) 302, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIG. 3. However, method 500 is not limited to that example embodiment. For example, the media device 106 may perform the operations described below with respect to method 500.

In step 510, a set of aesthetic frames is selected based on the aesthetic score. For example, based on aesthetic score 334 (which may be the positive score 330 minus the negative score 332), PG 302 may select a number of aesthetically pleasing frames (e.g., such as 100 frames with the highest aesthetic scores 334).

In step 520, a score prompt is generated for the VLM, the score prompt including the set of aesthetic frames as visual input and requesting an explanation and a corresponding final score as output. For example, prompt generator 324 may generate score prompt 339 and provide a set of frames selected based on the aesthetic score 334 as visual input to the VLM 304. The score prompt 339 may request VLM 304 to generate a final score 337 for the input frames based on how eye-catching the frame is for a movie poster and may request an explanation 336 for the final score. VLM 304 may then compare and contrast the input frames, generate final scores 337 and corresponding explanations 336 which contribute to creating a consistency between how the final scores 337 are generated by VLM 304.

In step 530, a set of candidate frames is selected based on the final score. For example, PG 302 may select a set of 25 frames with the 25 highest final scores 337. In other embodiments, other numbers of frames may be selected. In some embodiments, only the highest scoring frame(s) may be selected. For example, the final scores 337 may be: 97, 55, 32, 78, 97, and 97. Then, for example, only those three frames with a final score 337 of 97 may be selected as candidate preview frames 338.

In step 540, a candidate preview shot for each of the candidate frames is generated. For example, PG 302 may generate a candidate preview shot 340, which may include a plurality of frames adjacent to the candidate preview frame 338 in the content 308. The adjacent frames may include frames prior to and/or subsequent to preview frame 338. In some embodiments, preview shot 340 may be the shot 316 that includes the selected preview frame 338. In some embodiments preview 306 may include frames 317 across one or more shot 316.

In step 550, a negative score is generated for each of the candidate preview shots. For example, prompt generator 324 may use or alter negative prompt 328 as a preview prompt 342, and request VLM 304 to generate a preview shot score 343 for each of the candidate preview shots 340, to ensure no prohibited visual features exist in any of the frames in the candidate preview shot 340.

In some embodiments, in step 550, preview prompt 342 may include an instruction to VLM 304 to evaluate the candidate preview shots 340 for both positive features (from positive prompt 326) and negative features (from negative prompt 328) in generating the preview shot score 343. In some embodiments, preview prompt 342 may specify that no two preview shot scores 343 may be identical.

In step 560, the preview is selected from the candidate preview shots based on the negative score for each of the candidate preview shots. For example, if only negative features are accounted for in preview prompt 342, the candidate preview shot 340 with the lowest preview score 343 (e.g., lowest occurrence of negative features) may be selected as the preview 306. In some embodiments, if there are multiple candidate preview shots 340 with the same lowest preview score 343 or a preview score 343 below an acceptable threshold, then those preview shots 340 may be used as previews 306.

In some embodiments, if there are multiple candidate preview shots 340 with the same lowest preview score 343 or a preview score 343 below an acceptable threshold, a subsequent preview prompt 342 may be generated based on the occurrence of positive visual features in the remaining candidate previews shots 340 (if not already accounted for in preview prompt 342). Then, for example, VLM 304 may generate a new preview score 343 based on the occurrence of positive features, and the highest scoring preview shot(s) 340 may be selected as preview 306.

After one or more preview shots 340 are selected from amongst the candidate preview shots (based on the preview shot score 343), the selected preview shot(s) 340 may be made available to content server 310 and/or user interface 311. As noted above, if multiple preview shots 340 are selected as applicable previews 3206, those previews may be tested against each other based on user engagement, and the feedback 344 may be used to identify the highest performing preview 306 and/or refine the operations of generating subsequent previews 306.

### Example Computer System

Various embodiments may be implemented, for example, using one or more well-known computer systems, such as computer system 600 shown in FIG. 3. For example, the media device 106 may be implemented using combinations or sub-combinations of computer system 600. Also or alternatively, one or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics-processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

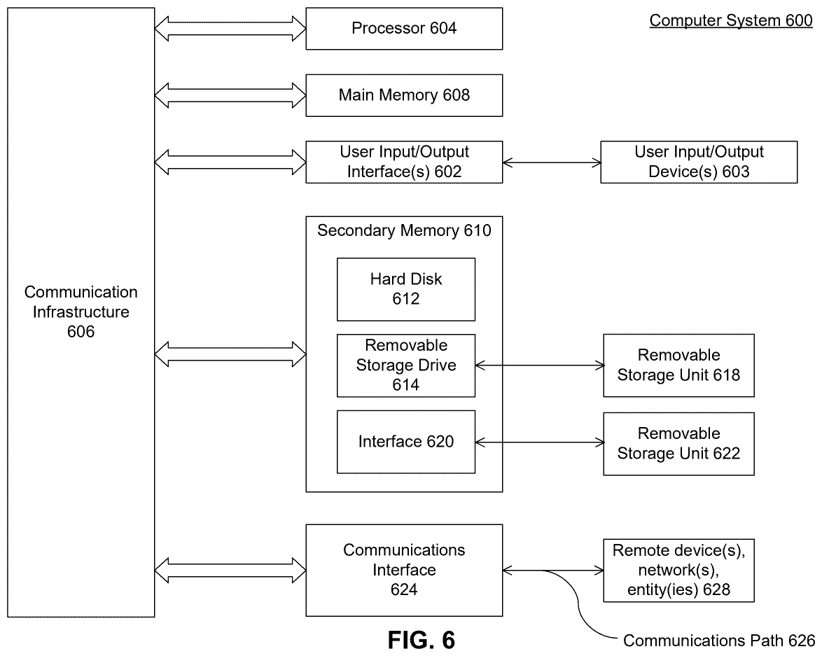

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for generating a preview of content, comprising:
identifying, by at least one computer processor, a plurality of shots within the content for which the preview of the content is to be generated, wherein each of the plurality of shots comprises a portion of the content comprising a plurality of adjacent frames;
calculating a sharpness indicator of at least a subset of the plurality of adjacent frames across each of the plurality of shots;
selecting a subset of sharpest frames, from the plurality of adjacent frames across each of the plurality of shots, based on the sharpness indicator;
providing the subset of sharpest frames to a visual language model (VLM) with a positive prompt indicating a favorable feature for the preview of the content and a negative prompt indicating an unfavorable feature for the preview of the content, wherein the VLM is configured to return a positive score for the positive prompt and a negative score for the negative prompt;
generating an aesthetic score for each of the subset of sharpest frames based on both the positive score and the negative score for each frame of the subset of sharpest frames;
selecting a preview frame from the subset of sharpest frames based on the aesthetic score;
generating the preview of the content based on the preview frame, wherein the preview of the content comprises a plurality of frames adjacent to the preview frame in the content; and
outputting the preview of the content.

2. The computer-implemented method of claim 1, further comprising:
selecting a set of aesthetic frames, from the subset of sharpest frames, based on the aesthetic score;
generating a scoring explanation prompt, for the VLM, the scoring explanation prompt including the set of aesthetic frames as input and requesting both an explanation of a final score and the final score as output; and
selecting a set of candidate frames, from the set of aesthetic frames, based on the final score.

3. The computer-implemented method of claim 2, further comprising:
generating a candidate preview for each of the candidate frames from the set of aesthetic frames, wherein the candidate preview comprises a plurality of frames adjacent to each of the candidate frames in the content;
receiving, from the VLM, a new positive score for each of the candidate previews in response to a new positive prompt, and a new negative score for each of the candidate previews in response to a new negative prompt; and
generating, for each of the candidate previews, a new aesthetic score based on the new positive score for the corresponding candidate preview and the new negative score for the corresponding candidate preview,
wherein the selecting the preview frame comprises selecting the preview frame from the candidate previews based on the new aesthetic score.

4. The computer-implemented method of claim 2, further comprising:
generating a candidate preview for each of the candidate frames from the set of aesthetic frames, wherein the candidate preview comprises a plurality of frames adjacent to each of the candidate frames in the content; and
receiving, from the VLM, a new negative score for each of the candidate previews in response to a new negative prompt.

5. The computer-implemented method of claim 4, wherein the selecting the preview frame comprises:
selecting the preview frame from the candidate previews based on the new negative score for each of the candidate previews.

6. The computer-implemented method of claim 1, wherein the sharpness indicator corresponds to a sharpness of a video portion of the multimedia content for the subset of the plurality of adjacent frames across one or more of the plurality of shots.

7. The computer-implemented method of claim 1, wherein the negative prompt indicates one or more prohibited portions of the content from which the preview frame cannot be selected.

8. A system for generating a preview of content, comprising:
one or more memories; and
at least one processor each coupled to at least one of the memories and configured to perform operations comprising:
identifying a plurality of shots within the content for which the preview of the content is to be generated, wherein each of the plurality of shots comprises a portion of the content comprising a plurality of adjacent frames;
calculating a sharpness indicator of at least a subset of the plurality of adjacent frames across each of the plurality of shots;
selecting a subset of sharpest frames, from the plurality of adjacent frames across each of the plurality of shots, based on the sharpness indicator;
providing the subset of sharpest frames to a visual language model (VLM) with a positive prompt indicating a favorable feature for the preview of the content and a negative prompt indicating an unfavorable feature for the preview of the content, wherein the VLM is configured to return a positive score for the positive prompt and a negative score for the negative prompt;
generating an aesthetic score for each of the subset of sharpest frames based on both the positive score and the negative score for each frame of the subset of sharpest frames;
selecting a preview frame from the subset of sharpest frames based on the aesthetic score;
generating the preview of the content based on the preview frame, wherein the preview of the content comprises a plurality of frames adjacent to the preview frame in the content; and
outputting the preview of the content.

9. The system of claim 8, the operations further comprising:
selecting a set of aesthetic frames, from the subset of sharpest frames, based on the aesthetic score;
generating a scoring explanation prompt, for the VLM, the scoring explanation prompt including the set of aesthetic frames as input and requesting both an explanation of a final score and the final score as output; and
selecting a set of candidate frames, from the set of aesthetic frames, based on the final score.

10. The system of claim 9, the operations further comprising:
generating a candidate preview for each of the candidate frames from the set of aesthetic frames, wherein the candidate preview comprises a plurality of frames adjacent to each of the candidate frames in the content;
receiving, from the VLM, a new positive score for each of the candidate previews in response to a new positive prompt, and a new negative score for each of the candidate previews in response to a new negative prompt; and
generating, for each of the candidate previews, a new aesthetic score based on the new positive score for the corresponding candidate preview and the new negative score for the corresponding candidate preview,
wherein the selecting the preview frame comprises selecting the preview frame from the candidate previews based on the new aesthetic score.

11. The system of claim 9, the operations further comprising:
generating a candidate preview for each of the candidate frames from the set of aesthetic frames, wherein the candidate preview comprises a plurality of frames adjacent to each of the candidate frames in the content; and
receiving, from the VLM, a new negative score for each of the candidate previews in response to a new negative prompt.

12. The system of claim 11, wherein the selecting the preview frame comprises:
selecting the preview frame from the candidate previews based on the new negative score for each of the candidate previews.

13. The system of claim 8, wherein the sharpness indicator corresponds to a sharpness of a video portion of the multimedia content for the subset of the plurality of adjacent frames across one or more of the plurality of shots.

14. The system of claim 8, wherein the negative prompt indicates one or more prohibited portions of the content from which the preview frame cannot be selected.

15. A non-transitory computer-readable medium having instructions stored thereon that, when executed by at least one computing device, cause the at least one computing device to perform operations for generating a preview of content, the operations comprising:
identifying a plurality of shots within the content for which the preview of the content is to be generated, wherein each of the plurality of shots comprises a portion of the content comprising a plurality of adjacent frames;
calculating a sharpness indicator of at least a subset of the plurality of adjacent frames across each of the plurality of shots;
selecting a subset of sharpest frames, from the plurality of adjacent frames across each of the plurality of shots, based on the sharpness indicator;
providing the subset of sharpest frames to a visual language model (VLM) with a positive prompt indicating a favorable feature for the preview of the content and a negative prompt indicating an unfavorable feature for the preview of the content, wherein the VLM is configured to return a positive score for the positive prompt and a negative score for the negative prompt;
generating an aesthetic score for each of the subset of sharpest frames based on both the positive score and the negative score for each frame of the subset of sharpest frames;
selecting a preview frame from the subset of sharpest frames based on the aesthetic score;
generating the preview of the content based on the preview frame, wherein the preview of the content comprises a plurality of frames adjacent to the preview frame in the content; and
outputting the preview of the content.

16. The non-transitory computer-readable medium of claim 15, the operations further comprising:
selecting a set of aesthetic frames, from the subset of sharpest frames, based on the aesthetic score;
generating a scoring explanation prompt, for the VLM, the scoring explanation prompt including the set of aesthetic frames as input and requesting both an explanation of a final score and the final score as output; and
selecting a set of candidate frames, from the set of aesthetic frames, based on the final score.

17. The non-transitory computer-readable medium of claim 16, the operations further comprising:
generating a candidate preview for each of the candidate frames from the set of aesthetic frames, wherein the candidate preview comprises a plurality of frames adjacent to each of the candidate frames in the content;
receiving, from the VLM, a new positive score for each of the candidate previews in response to a new positive prompt, and a new negative score for each of the candidate previews in response to a new negative prompt; and
generating, for each of the candidate previews, a new aesthetic score based on the new positive score for the corresponding candidate preview and the new negative score for the corresponding candidate preview,
wherein the selecting the preview frame comprises selecting the preview frame from the candidate previews based on the new aesthetic score.

18. The non-transitory computer-readable medium of claim 15, the operations further comprising:
generating a candidate preview for each of the candidate frames from the set of aesthetic frames, wherein the candidate preview comprises a plurality of frames adjacent to each of the candidate frames in the content; and
receiving, from the VLM, a new negative score for each of the candidate previews in response to a new negative prompt.

19. The non-transitory computer-readable medium of claim 18, wherein the selecting the preview frame comprises:
selecting the preview frame from the candidate previews based on the new negative score for each of the candidate previews.

20. The non-transitory computer-readable medium of claim 15, wherein the sharpness indicator corresponds to a sharpness of a video portion of the multimedia content for the subset of the plurality of adjacent frames across one or more of the plurality of shots.
